(19) United States
(12) Patent Application Publication
(10) Pub. No.: US 2026/0101976 A1
(43) Pub. Date: Apr. 16, 2026

(54) Shade for a Boom Lift

(71) Applicant: Jon J. Premo, Riverside, CA (US)

(72) Inventor: Jon J. Premo, Riverside, CA (US)

(73) Assignee: TNK Manufacturing Inc., Riverside, CA (US)

(21) Appl. No.: 18/912,431

(22) Filed: Oct. 10, 2024

(51) Int. Cl. A45B 23/00; B66F 11/04; B66F 13/00

(52) U.S. Cl. CPC A45B 23/00; B66F 11/044; B66F 13/00; A45B 2023/0025

(57) ABSTRACT

Improvements in a shade for a boom lift that provides a shade that covers all or most of the working area or cage of the boom lift. The shade protects the worker(s) from sunlight and the user may not need to wear a hat or other coverage to prevent direct sunlight on the worker(s). This provides sun protection that is not available on a boom shade or requires the user to select the side of a building they are working on based upon the direction and angle of the sun. The shade has two sets of upper and lower securing mechanisms. The bottom securing mechanism rests over the lower tube of the lift and the upper clamp securing mechanism extends at least partially over the upper rail to secure the shade in at least three locations. The clamping mechanism has a slot with threaded fasteners.

### CROSS-REFERENCE TO RELATED APPLICATIONS

Not Applicable.

### PRIOR ART

U.S. Pat. No. 8,342,224 issued on Jan. 1, 2013, to Roger R. Rountree and is titled Louver Shade Assembly. This patent discloses an architectural louver shade assembly comprising a shade canopy mounted to a rotatable central axle tube that supports a rod rib assembly to which the shade canopy is attached by adjustable tensioners that mechanically stretch and tension the fabric element of the shade canopy to remove wrinkles and sags. A wax cylinder piston attached by elements of a wax piston pressure system that changes the pitch of the shade canopy in response to temperature with a gas spring unit that returns the shade canopy to its default, horizontal orientation with decreasing temperatures. An optional manual/mechanical system that, through use of control cables, changes the pitch of the shade canopy with a gas spring unit that returns it to a default orientation. A camber cable assembly that maintains an equal compression load on the rib arm units that directly support the shade canopy, and carrier brackets that support the central axle tube and connect the louver shade assembly to a building wall. While this patent discloses a shade it does not include securing mechanism for attachment to a boom lift.

U.S. Patent published application 20110001022, was published on Jan. 6, 2011, to Alfred R. Edinger and is titled Universal Holding Device. This publication discloses a universal Holding Device has two embodiments, the second one possesses most of basic parts. One has an inverted “U” Shape and other has “L” shape designs. “U” shape design has three Holding Device Bodies, all have: Support Bracket, on right side of lower limb, moving left, than up is Clamping Device, move to upper limb, turn right is Clamping Device, move right than up is lower half of Hinge, On top is upper half of Hinge with a permanent securing device: i.e. Bolt, Nut, and temporary securing pin: i.e. Quick Release Pin, moving right is Ratchet-tooth, that rotates Adjustable Arm, 240.degree., moving right and resting on Adjustable Arm is Junction Bracket: i.e. two short tubes, one on top of the other forming a plus sign, each tube has its own Thumb Screws/Pull-Pins, turn right and inserted into other tube of Junction Bracket is Adjustable Rod, moving down to end is Attachment Bracket, with its Quick Release Pin. This publication is for a holding device but does not include shade for a boom lift.

U.S. Pat. No. 6,405,742 issued on Jun. 18, 2002, to James J. Driscoll and is titled Portable Sun Shade. This patent discloses a sun shade having an elongated member laterally supported from the end of a pole by a universal joint permitting rotational and angular movement of the member with respect to the longitudinal axis of the pole itself. The pole includes a telescoping arrangement whereby the pole can be lengthened or shortened at the discretion of the user. The end of the pole opposite to its end carrying the member includes a universal mount connected to a firm anchor or supported by a suitable clamp. While this patent discloses a shade it champs to a chair.

What is needed is a shade with an adjustable clamping mechanism that can be quickly and easily secured to a boom lift. The shade for a boom lift in this document provides the solution.

### BACKGROUND OF THE INVENTION

Using a boom lift requires user(s) to be subjected to the elements, and in particular the sun. The boom lift often places a user at or near the highest point of a building where there is limited, or no shade and the worker is subject to the heat and sun radiation as they work. The use of an umbrella or other shade device can be attached to the tubular boom lift rail but must be continuously moved to protect a worker. A shade needs to cover most or all the working areas for workers in the boom for protection as they work.

### SUMMARY OF THE INVENTION

It is an object of the shade for a boom lift to provide a shade that covers all or most of the working area or cage of the boom lift. The shade protects the worker(s) from sunlight and the user may not need to wear a hat or other coverage to prevent direct sunlight on the worker(s). This provides a level of sun protection that is not available on a boom shade or requires the user to select the sides of a building they will work on based upon the direction and angle of the sun.

It is an object of the shade for a boom lift for some embodiments of the shade to be adjustable for the angle of the shade over the boom. The angle of the shade can be changed or adjusted as the position of the sun relative to the boom lift changes throughout the day. In other embodiments the height of the shade can be changed based upon the height of the user, building topography, the area being painted or maintained. The side-to-side position of the shade can be adjusted by sliding the shade along the boom lift.

It is another object of the shade for a boom lift for the clamp to grip onto the railing of the boom lift. The shade has two sets of upper and lower securing mechanisms. The bottom securing mechanism rests over the lower tube of the lift and the upper securing mechanism extends at least partially over the upper rail to secure the shade in at least three locations.

It is another object of the shade for a boom lift to have an upper clamp that can be easily located over the upper rail of the boom lift. This makes the shade easy to install, move and remove the shade on a boom lift or onto another boom lift. It can also be moved from front to back (or vice versa) side of the boom lift depending upon desire or sun position.

It is still another object of the shade for a boom lift for the securing mechanism to quickly and solidly secure on the boom lift. This is accomplished with a clamping mechanism that has a slot with one or more threaded champs that secure the shade. It then requires an installer to unscrew the clamp for moving or repositioning the shade. The solid locking mechanism also provides a post that the user can grip or rest upon without fear of movement of the post/shade and provides some security from wind forces.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 shows a perspective view of a shade for a boom lift.

FIG. 2 shows a detailed view of the adjustable upper arm on one of the upright rails.

FIG. 3A-3C show more detail of the movable arm with the “U” channel.

FIG. 4 is a perspective view of the shade for a boom lift.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

Item Numbers and Description

| | |
|---|---|
| lower 16 lower frame tube | 17 upper frame tubes |
| 18 boom lift | 19 crane |
| 20 shade for a boom lift | 30 upright rail |
| 31 lower upright rail member | 32 bend |
| 35 upper frame | 40 shade |
| 41 shade frame | 42 hook and loop |
| 43 bend | 50 lower channel |
| 59 hook | 60 adjustable arm |
| 61 “U” channel | 62 lowered “U” channel |
| 63 height adjustment holes | 68 height |
| 69 travel | 70 movable arm |
| 71 narrow area | 72 ramp |
| 73 wide area | 74 indicia |
| 77 threads | 78 shoulder bolts |
| 79 hand nut | 80 slotted plate |
| 81 slot | 82 weld |
| 90 down | 91 angle |

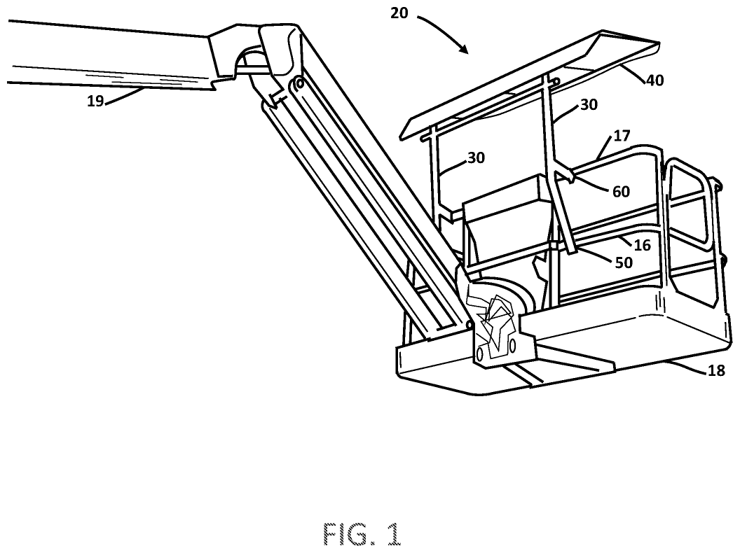

FIG. 1 shows a perspective view of a shade for a boom lift 20 in use. In this figure the upper extended portion of crane 19 is shown with a boom lift 18 secured thereon. An operator climbs inside of boom lift 18 and can operate crane 19 to position the boom lift 18 cage where desired to work. The shade for a boom lift 20 can be secured on either side of the boom lift cage 18 to provide shade to a worker in the boom lift 18.

The shade for boom lift 20 is constructed with two upright rails 30 that are securable onto the horizontal lower 16 and upper 17 frame tubes on the boom lift cage 18. Other figures herein show details of the securing mechanism and method of installation. In brief detail the lower channel 50 fits over the horizontal lower frame tube 16 and an adjustable upper arm 60 allows for secure fixing of the two upright rails 30 onto the boom lift 18.

The two upright rails 30 have a telescoping upper section that has a skeletal frame for securing a flexible shade 40 there on. This provides a shade covering to most or all the working area of the boom lift cage 18. The shade is configured, and show secured to the outside of the boom lift cage 18 so it does not infringe on the interior working area within the boom lift cage.

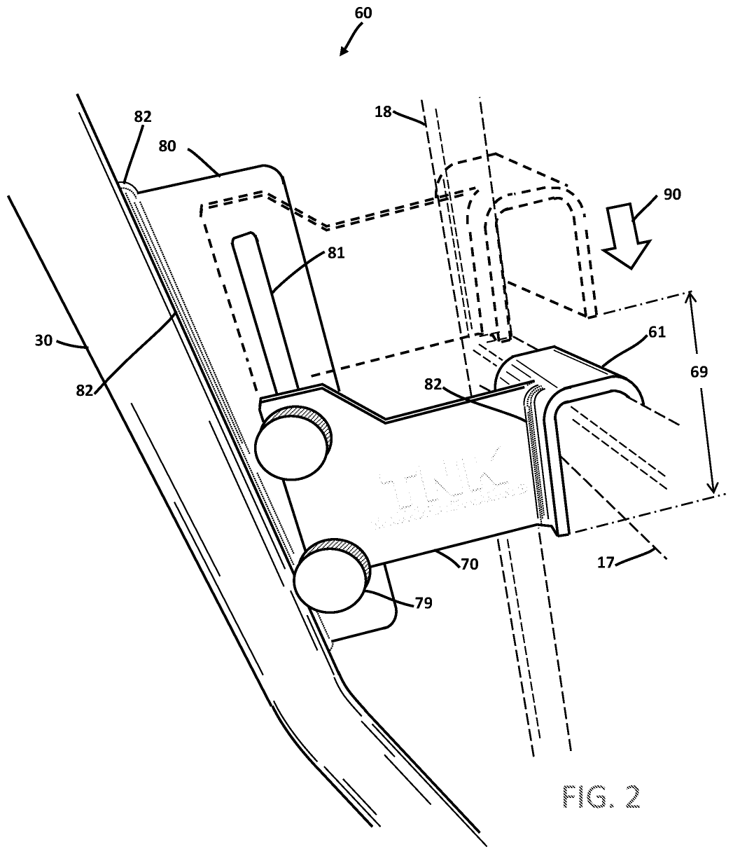

FIG. 2 shows a detailed view of the adjustable upper arm 60 on one of the upright rails 30. Each adjustable arm 60 rail clamp is essentially installed as mirror images so the hand nut 79 is accessed from the outside of the shade for a boom lift 20. This figure shows the upright rail 30 shown on the right of FIG. 1, the left side being essentially a mirror image thereof. Starting at the upright rail 30 a slotted plate 80 is welded 82 or otherwise secured to the upright rail 30. The slotted plate 80 has an upright slot 81 where the movable arm 70 is constrained to linear movement by the slot 81 for the adjustable upper arm 60 above and onto the upper 17 frame tube.

The movable arm 70 is secured on the slotted plate 80 with a plurality of bolts or more specifically in this embodiment, shoulder bolts are used with hand nut(s) 79. The shoulder bolts are shown and described in other figures herein. A “U” channel 61 is welded 82 or otherwise secured to the movable arm 70. The “U” channel is configured to fit over the upper frame tube 17.

The upper frame tube 17 is a tube that is a part of the boom lift frame 18. Broken lines show the movable arm 70 with the “U” channel 61 in an elevated or top of travel position, with the range of displacement or travel 69 that allows the “U” channel 61 to be lifted above the upper frame tube 17 and then lowered or travel 69 down onto the upper frame tube 17 where it can be secured with the hand nut(s) 79. In the preferred embodiment the travel 69 is about 4.5 inches, but a travel of more or less than 4.5 inches is contemplated.

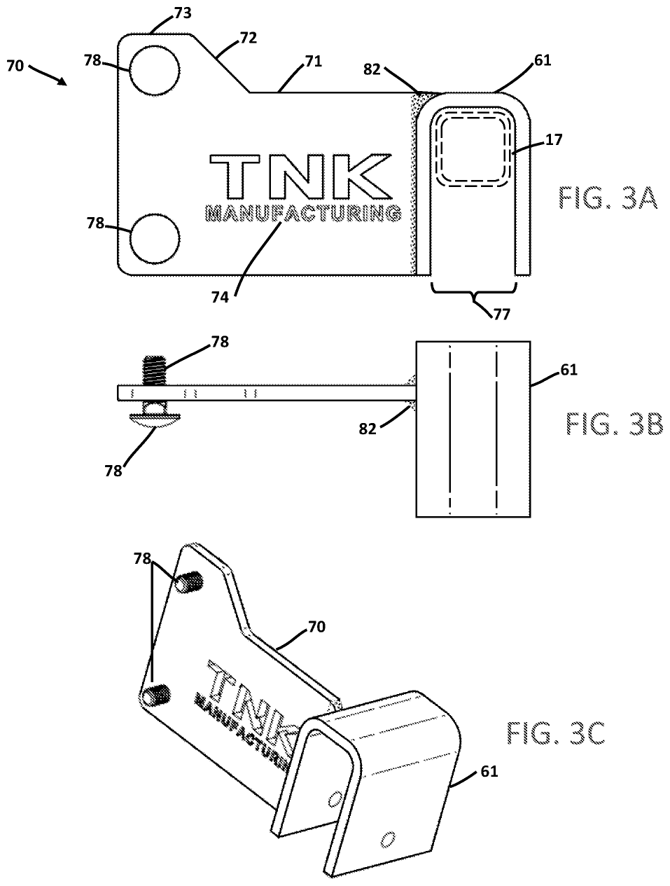

FIG. 3A-3C show more detail of the movable arm 70 with the “U” channel 61. FIG. 3B shows shoulder bolts 78 passing through the movable arm 70 with threads 77 on the shoulder bolt 78 on the other side of the movable arm 70 plate. Shoulder bolt 78 has a square shank portion that prevents the shoulder bolt 78 from turning in a square hole in the movable arm 70. While a shoulder bolt is shown and described, other similar fasteners are contemplated.

The plate of the movable arm has a narrower area 71 with a ramp 72 to a wider area 73 that supports the shoulder bolts 78. Indica 74 is shown on the movable arm 70 plate. Indicia 74 is shown on one side or passing through the face of the movable arm 70. While the figure shows specific indicia, other indicia are contemplated or no indicia. The ramp 71 transition allows the movable arm to be welded onto the “U” channel 61 and provide a longer tracking area for the shoulder bolts 78. The narrow area 17 is welded 82 or otherwise secured to the “U” channel 61.

The “U” channel 61 has a bottom opening 77 of the “U” channel 61 allows for capturing the upper frame tube 17 therein. The bottom opening 77 is sized to slide over the upper frame tube 17. Not shown in this figure is a separate “U” channel that is used on the bottom of the upright rail (not shown) to secure the shade for a boom lift 20 on the boom lift. The second “U” channel will be shown and described in more detail in other figures herein.

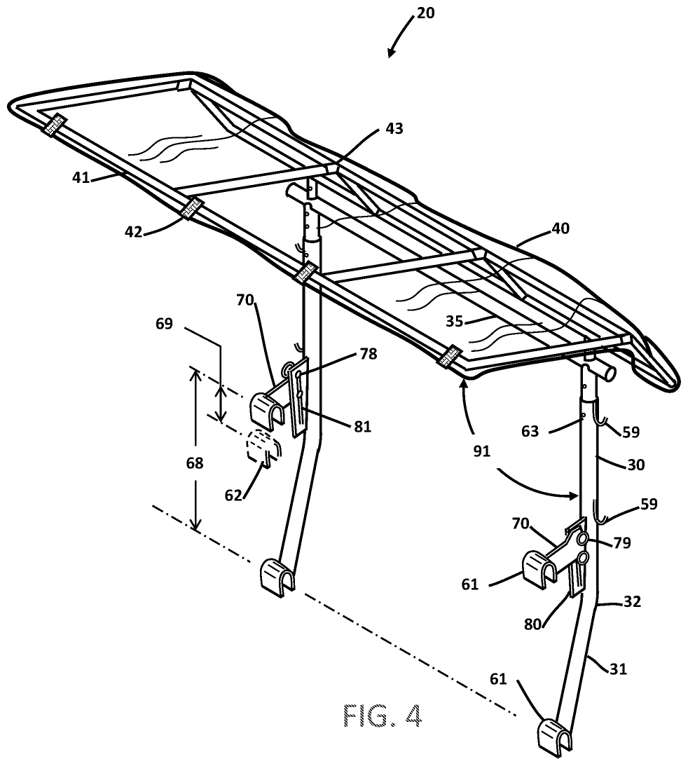

FIG. 4 is a perspective view of the shade for a boom lift 20. Starting at the bottom of this figure, each lower upright rail member 31 has a “U” channel 61 welded thereon. These “U” channel 61 parts are configured to fit over the lower rain on a boom lift (not shown). The lower upright rail 31 transitions with a bend 32 to the upright rail(s) 30. The bend 32 provides an offset to align the lower “U” channel 61 to the “U” channel on the movable arm(s) 70. The bend angle is preferably 2 to 10 degrees. In the embodiment shown the bend angle is 5 degrees.

The slotted plate 80 is shown welded onto upright rail 30. Each of the movable arms 70 are secured to the slotted plate(s) 80 with shoulder bolts 78 and hand nut(s) 79. A lowered “U” channel 62 is shown as it might engage over the rail of the boom lift (not shown. Movement 69 of this “U” channel 61/62 in slot 81 can be in the range of 2 to 10 inches, and more preferably 3 to 5 inches. The distance 68 between the lower and the top of the upper “U” brackets is contemplated at about 20 to 30 inches and more preferably 24 to 25 inches. A series of “J” hooks 59 are shown, and the “J” hooks can be used to suspend bags, equipment, hoses or other tool/paraphernalia.

A plurality of height adjustment holes 63 are shown at the top of upright rail 30 and at the lower portion of the upright tubes on upper frame 35 allow for elevating or lowering the height of the upper frame 35 from the upright rail(s) 30 and essentially the working platform of the boom crane (not shown). The adjustment is contemplated to be 6 to 24 inches in adjustment range. An angle 91 is shown from the upright rail 30 to the top frame of the shade frame 41. This angle is preferably from 90 to 135 degrees and more preferably 100 to 120 degrees. In the embodiment shown the angle 91 is set to 110 degrees, but adjustment of the angle 91 is contemplated in some embodiments.

Shade frame 41 is shown with a shade 40 made of fabric, screen or tarp material that blocks some or all of direct sunshine under the shade for a boom lift 20. A series of hook-and-loop fasteners 42, or similar securing mechanism is used to hold the shade onto the shade frame. Frame 41 has a bend 43 that provides some horizontal shade as well as overhead shade.

To secure the shade for boom lift 20 onto a boom lift, first the lower “U” clamps 61 are placed on the lower rail of the boom lift. Each of the movable arms 70 are then lowered until the upper “U” clamps 61 grasp the upper rail of the boom lift. The hand nuts 79 are then tightened to secure the shade for a boom lift 20 onto the boom lift cage. Removal of the shade for boom lift 20 is performed in the reverse order.

Thus, specific embodiments of a shade for a boom lift have been disclosed. It should be apparent, however, to those skilled in the art that many more modifications besides those described are possible without departing from the inventive concepts herein. The inventive subject matter, therefore, is not to be restricted except in the spirit of the appended claims.

1. A shade for a boom lift comprising:
a left and a right upright rail member;
each of said left and said right upright rail member having a lower “U” channel secured at a first lower end thereon;
said lower “U” channel being configured to fit over a lower rail of a boom lift;
each of said left and said right upright rail member having a shade frame secured at a second upper end thereon;
a slotted plate secured to each of said left and said right upright rail member between said first lower end and said second upper end;
said slotted plate having an essentially upright slot;
adjustable arms having at least two fasteners for securing each said adjustable arm on each said slotted plate through said essentially upright slot;
each adjustable arm having an upper “U” channel secured thereon;
said adjustable arm being configured to translate on said slotted plate to move each of said upper “U” channels over an upper rail of a boom lift;
said shade frame extending over said left and said right upright frame member, and a flexible shade extending over and being secured to said shade frame.

2. The shade for a boom lift according to claim 1, wherein said left and said right upright rail members are bent near said slotted plate.

3. The shade for a boom lift according to claim 2, wherein said bend is below said slotted plate.

4. The shade for a boom lift according to claim 3, wherein said bend positions said upper “U” channel essentially parallel with said lower “U” channel.

5. The shade for a boom lift according to claim 2, wherein said bend is between 90 and 135 degrees when measured from said upright rail member and said shade frame.

6. The shade for a boom lift according to claim 5, wherein said bend is between 100 and 120 degrees when measured from said upright rail member and said shade frame.

7. The shade for a boom lift according to claim 1, wherein said upright slot is configured for said upper “U” channel to linearly move between 2 to 10 inches.

8. The shade for a boom lift according to claim 7, wherein said upright slot is configured for said upper “U” channel to linearly move between 3 to 5 inches.

9. The shade for a boom lift according to claim 1, wherein said flexible shade is secured to said shade frame with at least two hook-and-loop fasteners.

10. The shade for a boom lift according to claim 1, wherein said at least two fasteners are shoulder bolts.

11. The shade for a boom lift according to claim 10, wherein said shoulder bolts are secured with hand nuts.

12. The shade for a boom lift according to claim 1, wherein said frame shade is uprightly adjustable relative to said left and said right upright rail member.

13. The shade for a boom lift according to claim 1, wherein said shade frame has a bend that provides some horizontal and some overhead shade.

14. The shade for a boom lift according to claim 1, wherein each said slotted plate is welded to each of said left and said right upright rail members.

15. The shade for a boom lift according to claim 1, wherein said “U” channel is welded to said adjustable arm.

16. The shade for a boom lift according to claim 1, wherein and angle of said shade frame is adjustable.

17. The shade for a boom lift according to claim 1, further includes a boom lift cage having a lower rail and an upper rail.

18. The shade for a boom lift according to claim 17, wherein said frame shade is uprightly adjustable relative to said boom lift cage.

19. The shade for a boom lift according to claim 17, wherein said lower “U” channel at least partially wraps over said lower rail of said boom lift cage and said upper “U” channel at least partially wraps around said upper rail of said boom lift cage.

20. The shade for a boom lift according to claim 19, wherein said left and said right upright rail members are configured to be secured to an outside of said boom lift cage.
